(19) United States
(12) Patent Application Publication
(10) Pub. No.: US 2023/0020440 A1
(43) Pub. Date: Jan. 19, 2023

(54) OPTICAL COUPLER

(71) Applicants: John Heck, Berkeley, CA (US); Harel Frish, Albuquerque, NM (US); Hari Mahalingam, San Jose, CA (US); Haisheng Rong, Pleasanton, CA (US)

(72) Inventors: John Heck, Berkeley, CA (US); Harel Frish, Albuquerque, NM (US); Hari Mahalingam, San Jose, CA (US); Haisheng Rong, Pleasanton, CA (US)

(21) Appl. No.: 17/955,378

(22) Filed: Sep. 28, 2022

(51) Int. Cl. G02B 6/30

(52) U.S. Cl. CPC G02B 6/305; G02B 2006/12061

(57) ABSTRACT

Embodiments may include or relate to an optical coupler. The optical coupler may include a silicon nitride (SiN) waveguide. The waveguide may be formed by placing SiN on an epitaxially grown silicon structure that is then removed subsequent to placement of the SiN. Other embodiments may be described and/or claimed.

### BACKGROUND

Embodiments of the present disclosure generally relate to the field of optical couplers for silicon photonic chips. Generally, an optical coupler may coupler an optical source (e.g., a laser or some other optical source) with an optical receiver (e.g., an optical fiber, or some other optical component). It may be desirable for silicon photonic chips to have efficient optical coupling to optical fibers or other optical components.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1A and 1B (collectively, “FIG. 1”) illustrate different views of an example optical coupler, in accordance with various embodiments.

FIG. 2 illustrates an example stage of a manufacturing process of the optical coupler of FIG. 1, in accordance with various embodiments.

FIG. 3 illustrates another example stage of the manufacturing process of the optical coupler of FIG. 1, in accordance with various embodiments.

FIG. 4 illustrates another example stage of the manufacturing process of the optical coupler of FIG. 1, in accordance with various embodiments.

FIG. 5 illustrates another example stage of the manufacturing process of the optical coupler of FIG. 1, in accordance with various embodiments.

FIG. 6 illustrates another example stage of the manufacturing process of the optical coupler of FIG. 1, in accordance with various embodiments.

FIG. 7 illustrates an example process for the manufacture of the optical coupler of FIG. 1, in accordance with various embodiments.

FIG. 8 illustrates an example computing system suitable for practicing various aspects of the disclosure, in accordance with various embodiments.

FIG. 9 illustrates an example non-transitory computer-readable storage medium having instructions configured to practice all or selected ones of the operations associated with the processes described in reference to FIGS. 7 and 8, and/or some other process, method, technique, or operation described herein, in whole or in part.

FIG. 10 depicts an example silicon photonic chip, in accordance with various embodiments.

### DETAILED DESCRIPTION

Embodiments described herein may include apparatus, systems, techniques, or processes that are directed to an optical coupler for use in a silicon photonic chip. Specifically, the optical coupler may be manufactured through the use of an epitaxially-grown silicon mold that is used to guide the formation of a silicon nitride (SiN) waveguide. After the SiN waveguide is formed, the silicon mold may be removed, leaving behind a cavity. When an optical signal travelling through the SiN waveguide encounters the cavity, the respective indices of refraction between the SiN waveguide and the cavity may cause the light to reflect when it encounters the face of the SiN waveguide that is adjacent to the cavity.

Through the use of the epitaxially-grown silicon mold, the face of the SiN waveguide that abuts the cavity (referred to herein as the “reflective face of the SiN waveguide”) may have a variety of properties or features. Specifically, in some cases the reflective face of the SiN waveguide may be offset from a surface of a silicon substrate of the optical coupler by an angle of greater than 50 degrees (°). Legacy optical couplers may have been generally limited to an angle of approximately 45° based on their process of manufacture. Specifically, a legacy optical coupler may have been manufactured using a grayscale lithographic etch in a silicon oxide (SiO₂) layer, and subsequently backfilling the trench with SiN. The SiO₂ etch may have only been able to achieve an approximately 45° angle with respect to the surface of the silicon substrate. The increased angle of the optical coupler of embodiments herein may be due to the epitaxially grown silicon layer described in greater detail below, which may result in a (111) crystal plane angle.

Additionally, the reflective face of the SiN waveguide of embodiments herein may have the benefit of having a generally linear profile. Such a profile may be desirable because it may provide for greater consistency and control regarding the direction in which the optical signal is reflected. By contrast, legacy optical couplers may have had a reflective face with an inherently curved (e.g., convex or concave) shape. Such a curved shape may have been based on inherent limitations of the lithographic etch, described above. Additionally, the reflective face of the SiN waveguide may be very smooth, leading to reduced optical loss upon reflection. For example, in some embodiments the reflective face of the SiN waveguide may have a roughness of less than 10 nanometers (nm). In some cases, the roughness may be less than approximately 1 nm.

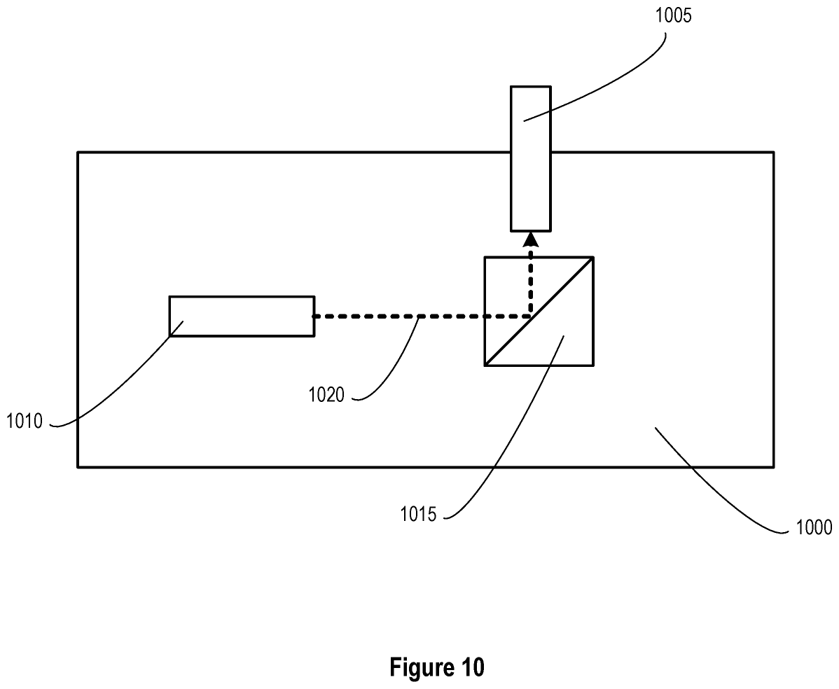

FIG. 10 depicts an example environment in which an optical coupler may be used. Specifically, FIG. 10 depicts an example photonic chip 1000. The photonic chip 1000 may include an optical source 1010. The optical source 1010 may be configured to generate one or more optical (i.e., light) signals 1020. Generally, the optical source 1010 may be referred to as a laser. In other embodiments, the optical source 1010 may be some other type of chip or device such as an optical fiber along which an optical signal has transferred.

The optical signals 1020 may be output from the optical source 1010 and intended to be transmitted to an optical receiver 1005. The optical receiver 1005 may be, for example, an optical fiber, an optical cable, or a component of an electronic device that is configured to receive and/or process the optical signals 1020. As shown in FIG. 10, in some embodiments the optical source 1010 and the optical receiver 1005 may not be co-planar with one another. In these embodiments, an optical coupler 1015 in accordance with various embodiments herein may be used. The optical coupler 1015 may be configured to alter a direction of travel of the optical signals 1020 as shown in FIG. 10.

It will be understood that the embodiment of FIG. 10 is intended as one example embodiment. In other embodiments, other photonic chips 1000 may have more or fewer components than are shown in FIG. 10. In some embodiments, the components of FIG. 10 may be implemented on two or more photonics chips. Similarly, in some embodiments the size of configurations of the different elements may be different than depicted. Other embodiments may vary.

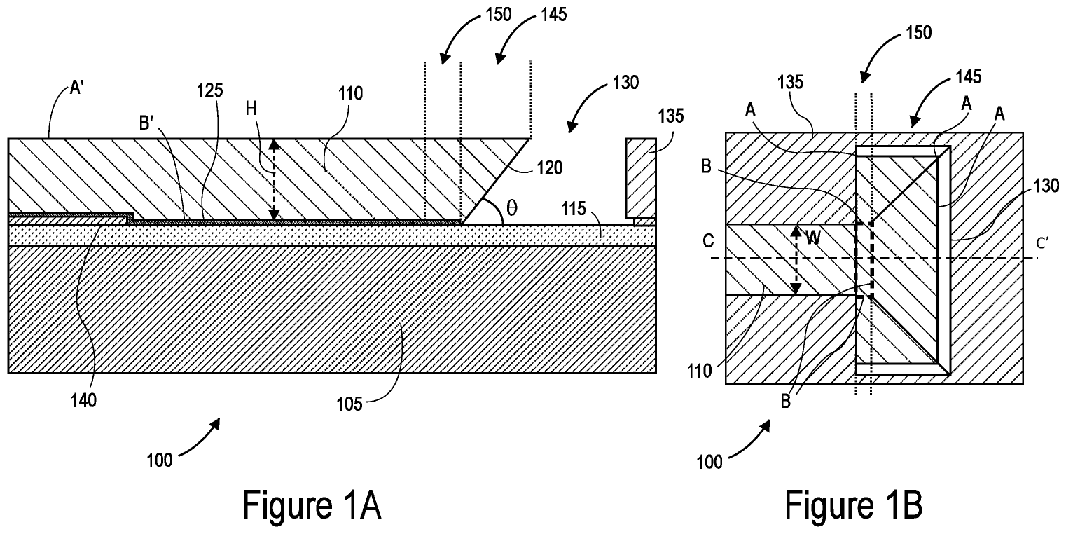

FIG. 1 illustrates different views of an example optical coupler 100, in accordance with various embodiments. Specifically, FIG. 1B illustrates a top-down view of the optical coupler 100. FIG. 1A illustrates a cross-sectional view of the optical coupler 100 taken along line C-C′. It will be understood that, for the sake of discussion of embodiments herein, an optical signal may enter from the left side of FIGS. 1A or 1B. The optical signal may be reflected such that it exits the optical coupler 100 generally vertically upward (as oriented in FIG. 1A) or out of the paper (as oriented in FIG. 1B).

The optical coupler 100 may include a variety of layers. One such layer may be the silicon substrate layer 105. In some embodiments, the silicon substrate layer 105 may be a layer of the photonic chip (e.g., photonic chip 1000) of which the optical coupler 100 is a part. In other embodiments, the silicon substrate layer 105 may be an element that is separate from, but adhered to, the photonic chip.

The optical coupler 100 may further include a buried oxide layer 115. The buried oxide layer 115 may be formed of, for example, silicon dioxide (SiO₂) or some other oxide material. The buried oxide layer 115 may serve a variety of purposes. For example, the buried oxide layer 115 may serve as a cladding to keep optical signals from passing from other portions of the optical coupler 100 into the silicon substrate layer 105. In some embodiments, the buried oxide layer 115 may additionally act as a thermal barrier to mitigate the amount of heat that passes from an optical source (e.g., optical source 1010) and/or the optical coupler 100 into the silicon substrate layer 105. In some embodiments, as will be described in greater detail below, the buried oxide layer 115 may additionally act as an etch-stop layer to prevent an etch process from affecting the silicon substrate layer 105.

A thin silicon nitride layer 125 may be positioned at least partially on the buried oxide layer 115. As will be described below, the silicon nitride layer 125 may act as an etch-stop layer during the manufacture of the optical coupler 100.

The optical coupler 100 may further include a thick silicon nitride (SiN) layer 110. The SiN layer 110 may act as a waveguide for an optical signal received from a silicon waveguide 140, which may itself be attached to or part of an optical source such as optical source 1010. Specifically, the silicon waveguide 140 may help to shape and guide the optical signal as it enters the optical coupler 100. However, it may be difficult to efficiently change the direction if the optical signal is too narrow/focused. As such, the SiN layer 110 may have a profile that allows the optical signal to expand within the SiN layer 110 such that it may be reflected at a face 120 of the SiN layer 110. As such, the SiN layer 110 may have a height H of between approximately 3 and approximately 10 micrometers (“microns”). In some embodiments, the height H may be approximately 4 micrometers (“microns”). Similarly, the SiN layer 110 may have a width W of between approximately 3 and approximately 10 microns. In some embodiments, the width W of the SiN layer 110 may be approximately 4 microns. In general, the width W or height H of the SiN layer 110 may be selected based on various factors such as the bandwidth, energy, or intensity of the optical signal, the specific materials being used for different layers, etc. Generally, the width W and height H may be similar to one another such that the SiN layer 110 has a substantially square cross-sectional profile.

As shown the face 120 of the SiN layer 110 may have an angle θ from the surface of the silicon layer 105 upon which the SiN layer 110 is positioned or, more accurately, the surface of the buried oxide layer 115 that is positioned on the silicon substrate layer 105. In embodiments, the angle θ may be between approximately 45 and 54.7°. In some embodiments, the angle θ may be less than approximately 50°.

Additionally, as noted, the face 120 may be relatively smooth. For example, in some embodiments the face 120 may have a smoothness coefficient of less than or equal to approximately 10 nm. In some cases, the face 120 may be even smoother and have a smoothness coefficient of less than or equal to approximately 1 nm.

As may be seen in FIG. 1, a cavity 130 may be present that undercuts at least a part of the SiN layer 110. Generally, the cavity 130 may be defined by the SiN layer 110 and an oxide layer 135 that at least partially surrounds the SiN layer 110. The oxide layer 135 may be formed of, for example silicon dioxide or some other polymer. In some embodiments, the oxide layer 135 may have a refractive index of less than or equal to approximately 1.5.

The cavity 130 may be filled with or contain a gas (e.g., air or an inert gas). Generally, the cavity 130 may be filled with or contain a material that has a refractive index that is lower than that of the SiN layer 110. For example, in various embodiments the SiN layer 110 may have a refractive index of approximately 2.0-2.4. Therefore, it may be desirable for the cavity to be filled with or contain a material that has a refractive index of less than 2.0 and, more generally, on the order of 1.5 or below. As a result, when the optical signal encounters the face 120 of the SiN layer 110 that is adjacent to the cavity 130, the optical signal may be reflected as described above. In some embodiments, rather than air, the cavity 130 may be filled with silicon dioxide or other low-index dielectric material. It may also be coated with a metallic reflective layer. Generally, it will be understood by one of skill in the art that the specific material within the cavity 130 may be selected to accomplish total internal reflection of a light signal that propagates through the SiN layer 110 and is reflected at the face 120 as described herein.

It will be noted that, in some embodiments, the width of the SiN layer 110 at or adjacent to the cavity 130 may be greater than the width of the SiN layer 110 at a portion further away from the cavity. For example, in some embodiments the SiN layer 110 may have a width of approximately 3 times the length of portion 145 of the SiN layer 110. Additionally, as may be seen at FIG. 1B, the cavity 130 may at least partially extend beyond a boundary of the SiN layer 110 on at least three sides of the SiN layer 110.

Additionally, it will be appreciated that the SiN layer 110 adjacent to the cavity 130 may have an at least partially inverted frustopyramidal shape. The points marked A in FIG. 1B may correspond to height A′ in FIG. 1A. Similarly, the points marked B in FIG. 1B may correspond to height B′ in FIG. 1A. To put it another way, the face 120 (and other faces of the SiN layer 110 that are adjacent to the cavity 130) may be at a lowest point B′ at an interior portion of the face 120, and raise to a height A at an exterior portion of the face 120.

It will further be noted that the SiN layer 110 may extend at least partially beyond the point where the SiN layer 110 widens before the face 120 of the SiN layer begins to rise from the buried oxide layer 115. Such extension is indicated in FIG. 1 by portion 150. The purpose of such extension may be to allow for further expansion of the optical signal in the SiN layer 110 prior to reflection.

In embodiments, the face 120 (and other faces of the SiN layer 110 adjacent to the cavity 130) may have a generally linear profile. As described above, the linear profile may result from the process of forming the SiN layer 110 described herein through the use of an epitaxially grown silicon mold upon which the SiN layer 110 is deposited. As previously described, legacy embodiments that relied upon a grayscale etch process may have resulted in an optical coupler with a face (similar to face 120) that was curved in some way. Therefore, the techniques described herein may provide a significant benefit in terms of consistency of reflection and, ultimately, the overall efficiency of the optical coupler 100.

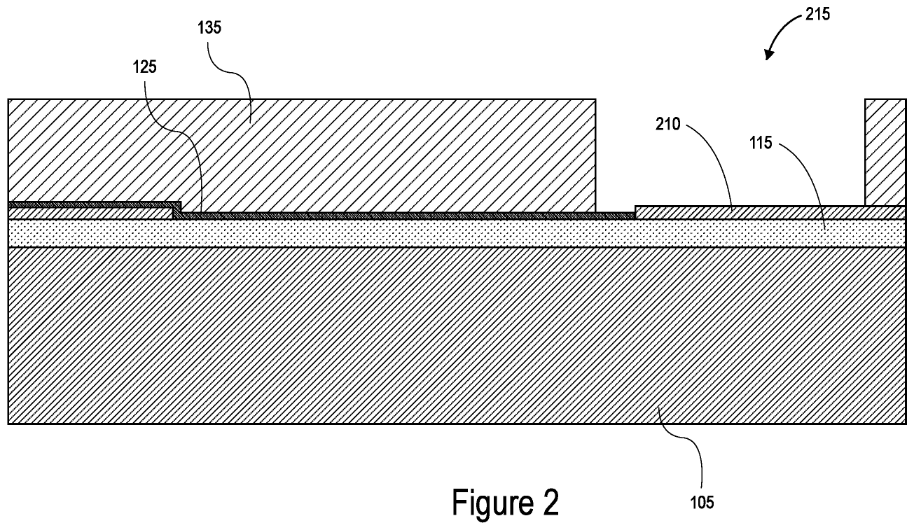

FIGS. 2-6 provide examples stages of manufacture of the optical coupler 100 of FIG. 1. Generally, FIGS. 2-6 are provided along the same cross-sectional line C-C′ as FIG. 1A.

Specifically, FIG. 2 depicts an initial stage of manufacture of the optical coupler 100. In FIG. 2, oxide layer 135 may be positioned on the silicon substrate 105 and/or the buried oxide layer 115. A cavity 215 may be formed in the oxide layer 135. The cavity 215 may be formed through an etching process such as chemical etching, lithographic etching, physical etching, etc. The etching process may reveal a silicon layer 210. The silicon layer 210 may be referred to as a “template layer” or a “seed layer.”

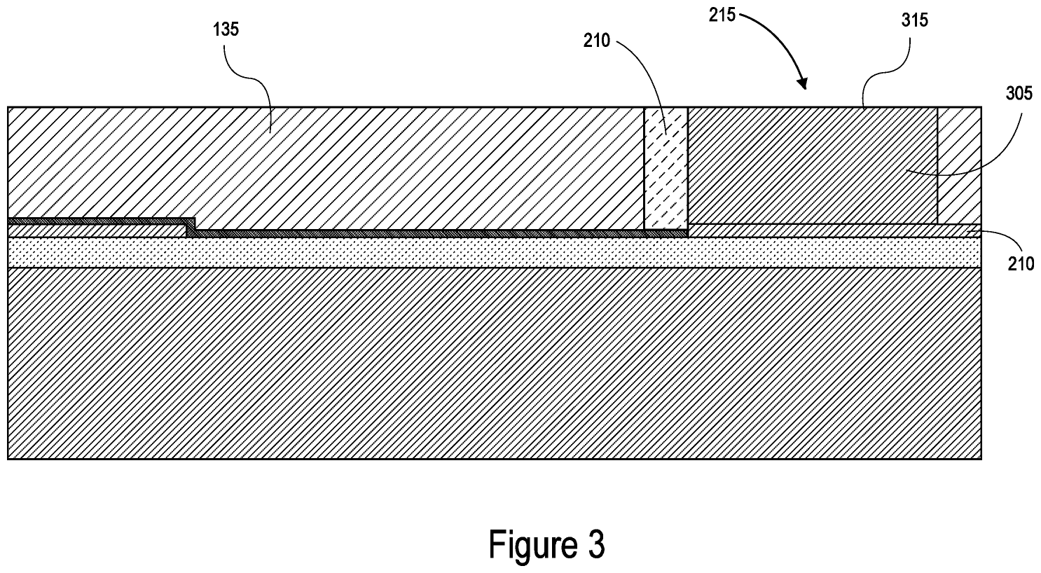

In FIG. 3, silicon may be grown epitaxially in the cavity 215. Specifically, in the area of the cavity 215 above the silicon layer 210, the epitaxial layer may be crystalline as shown at 305. In the area of the cavity 215 that is not above the silicon layer 210, the epitaxial layer may be polycrystalline as shown at 310. In some embodiments, the epitaxy process may use selective growth, while other embodiments may use non-selective growth. Subsequently to the epitaxy process, a polish process may be performed on the exposed surface 315 of the silicon 305/310.

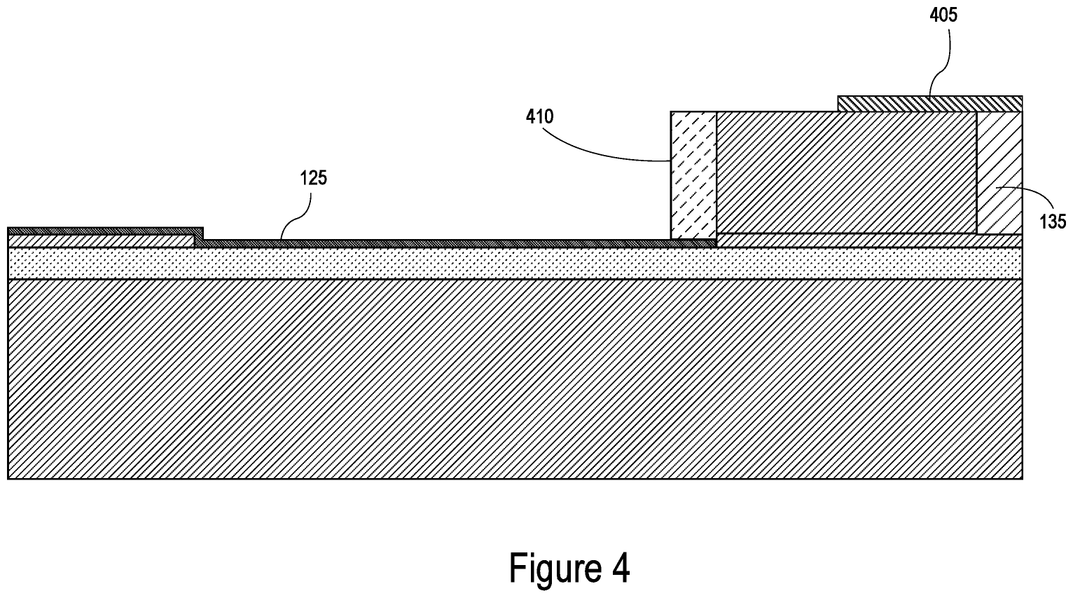

In FIG. 4, at least a portion of the oxide layer 135 may be removed. It will be understood, for example by review of FIG. 1B, that portions of the oxide layer 135 adjacent to where the SiN layer will be placed may not be removed. In other words, the portions of the oxide layer 135 may be removed to form a “trench” type structure such that a face 410 of the silicon structure (e.g., element 305 and 310) may be exposed. In embodiments, the oxide layer 135 may be removed through an etching process such as a physical, mechanical, chemical, and/or lithographic etch, or some other type of etch process. As previously described, in some embodiments the nitride layer 125 may serve as an etch-stop during the etching process.

In some embodiments, prior to the etch, a hardmask 405 may be deposited on at least a portion of the surface 315 of the epitaxially grown silicon 305/310 to protect the silicon during the etching process. In embodiments, the hardmask 405 may be or include SiN or some other material.

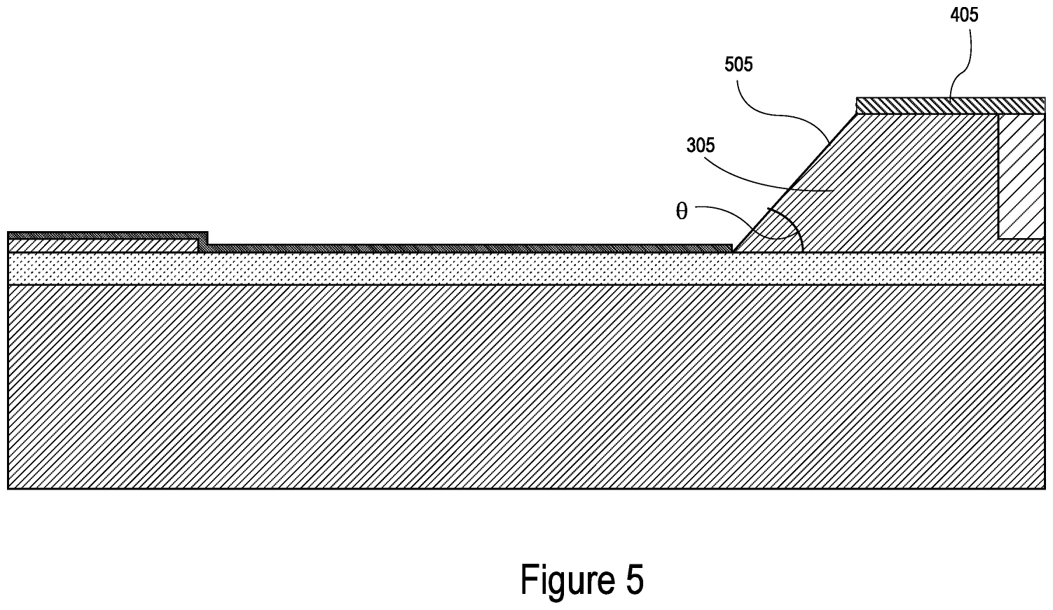

In FIG. 5, the silicon (element 305/310) may be etched using a crystallographic etchant such as potassium hydroxide (KOH), tetramethylammonium hydroxide (TMAH), an aqueous solution of ethylene diamine and pyrocatechol (EDP), and/or some other type of crystallographic etchant. As may be seen in FIG. 5, some or all of the polycrystalline silicon 310 may be removed, and at least a portion of the crystalline silicon 305 may be etched. The hardmask 405 may at least partially protect a portion of the silicon 305 during the etching process.

As a result, the crystalline silicon 305 may from a (111) facet 505. Such a facet may have a frustopyramidal shape similar to that described above with respect to FIG. 1. Specifically, the facet 505 may be viewed as the mold that is used to form the inverse frustopyramidal shape of the SiN layer 110 as described above with respect to FIG. 1. In embodiments, the facet 505 may have an angle θ, which may be similar to the angle θ described above with respect to FIG. 1. It will be noted that, with changes to the etch chemistry, the slope may be reduced to an angle closer to 45°. It will be understood that, in another embodiment, the surface 505 may be a (110) plane of silicon, and therefore may make a 45° angle. Such a planar surface may be generated by rotating the waveguide in-plane and using alternative etch chemistries.

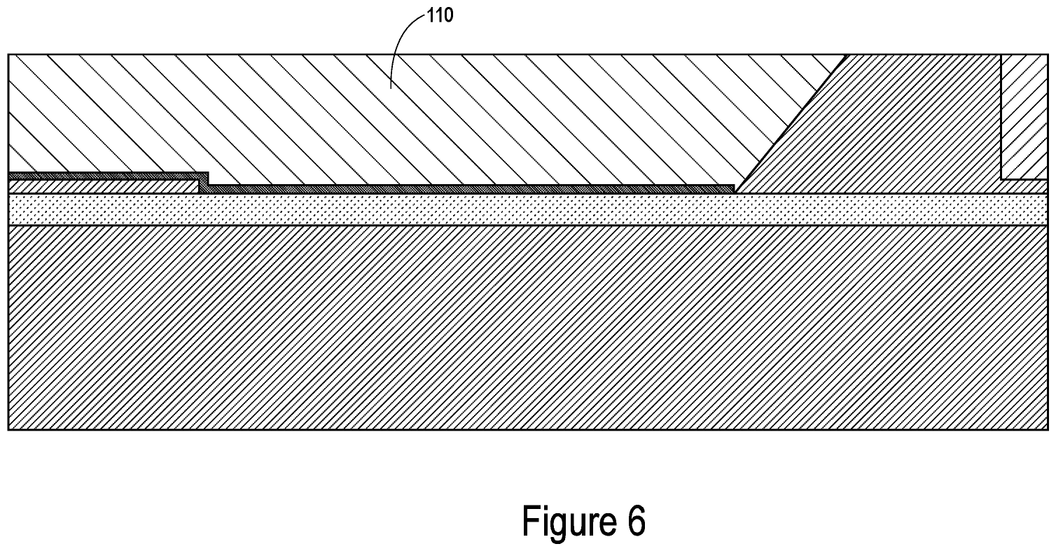

Subsequently, as shown in FIG. 6, the hardmask 405 may be removed, for example by etching, and the SiN layer 110 may be deposited. In some embodiments, the SiN layer may further be polished, for example through a mechanical and/or chemical polish.

Then the silicon (e.g., element 305) may be removed to form the optical coupler 100 of FIG. 1. In embodiments, the crystalline silicon 305 may be removed by an isotropic etch process such as a noncrystallographic wet etch, a plasma etch, a vapor phase etch, etc.

It will be understood that the elements of FIGS. 1-6 and 10 are intended as simplified examples for the sake of discussion herein. The specific scale, location, and/or configurations of various elements are intended as illustrative rather than limiting, unless explicitly stated otherwise. It will also be understood that other embodiments may include more or fewer elements than are depicted.

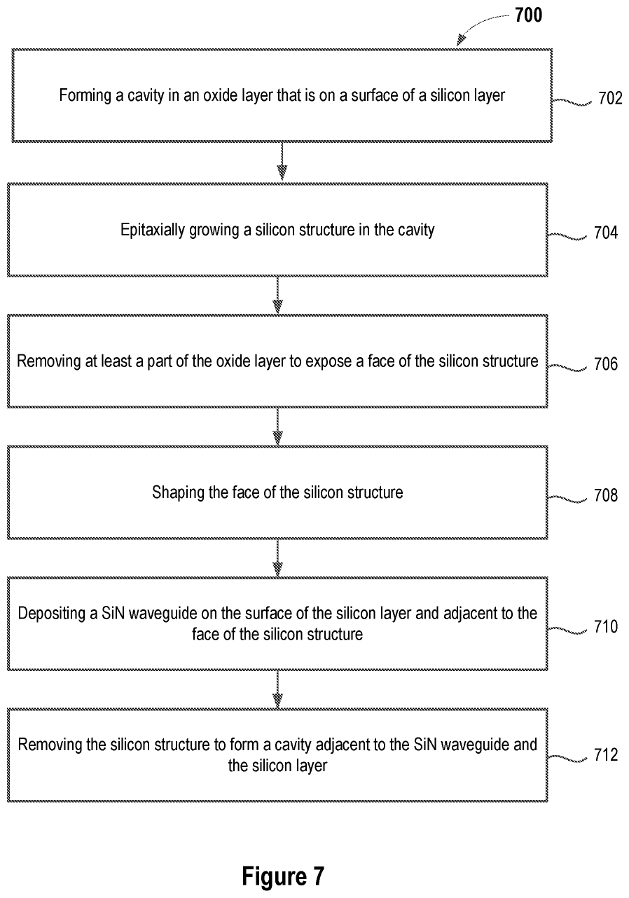

FIG. 7 illustrates an example process 700 for the manufacture of the optical coupler 100 of FIG. 1, in accordance with various embodiments. The process 700 may be performed, for example, by the system 800 (e.g., computing device). Specifically, a computing device such as computing device 800 may control machinery to manufacture the optical coupler 100. Generally, the process 700 may be described with respect to elements of FIGS. 1-6.

The process 700 may include forming, at 702, a cavity in an oxide layer that is on a surface of a silicon layer. The cavity may be, for example, cavity 215 that is formed in oxide layer 135 on the surface of the silicon substrate layer 105 as shown in FIG. 2.

The process 700 may further include epitaxially growing, at 704, a silicon structure in the cavity. Such a silicon structure may be, for example, the silicon elements 305 and 310 depicted in FIG. 3.

The process 700 may further include removing, at 706, at least a part of the oxide layer to expose a face of the silicon structure. The face may be similar to, for example, face 410 as depicted in FIG. 4.

The process 700 may further include shaping, at 708, the face of the silicon structure. Such shaping may be the etch process described and depicted with respect to FIG. 5 which forms the facet 505.

The process 700 may further include depositing, at 710, a SiN waveguide on the surface of the silicon layer and adjacent to the face of the silicon structure. The SiN waveguide may be, for example, the SiN layer 110 as depicted in FIG. 6.

The process 700 may further include removing, at 712, the silicon structure to form a cavity adjacent to the SiN waveguide and the silicon layer. Removal of the silicon structure may include the crystallographic etch previously described. As previously noted, such removal may result in formation of the cavity 130 as previously described.

It should be understood that the actions described in reference to FIG. 7 may not necessarily occur in the described sequence. For example, certain elements may occur in an order different than that described, concurrently with one another, etc. In some embodiments, the process 700 may include more or fewer elements than depicted or described.

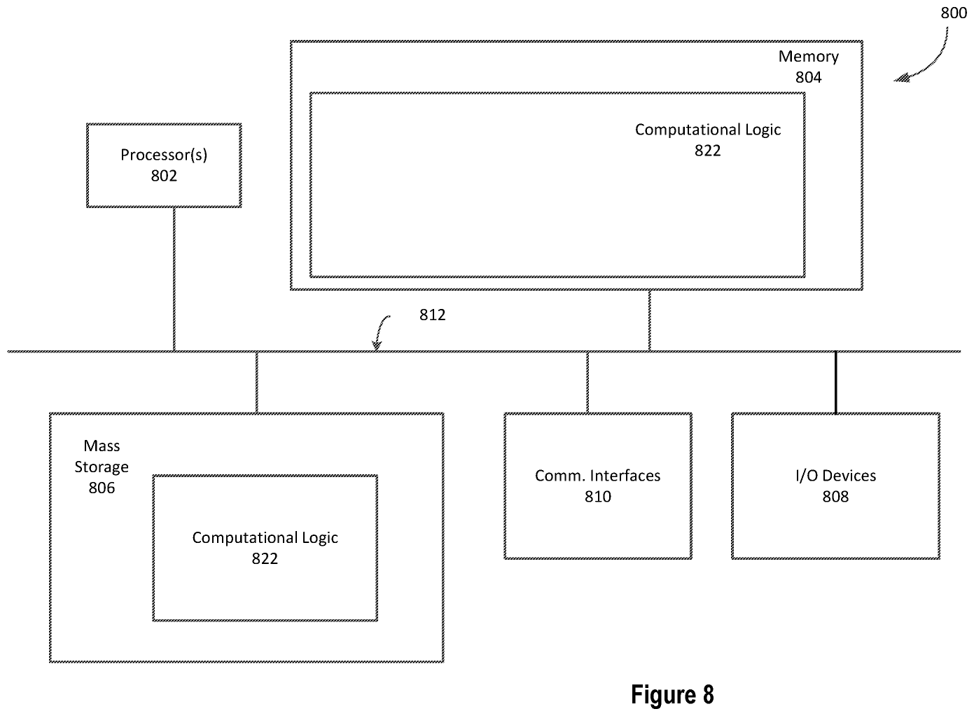

FIG. 8 illustrates an example computing device 800 suitable for use to practice aspects of the present disclosure, in accordance with various embodiments. For example, the example computing device 800 may be suitable to implement the functionalities, methods, techniques, or processes, in whole or in part, associated with any of FIGS. 1-7, and/or some other process or technique described herein. In other embodiments, the computing device 800 may include and/or implement an optical coupler such as optical coupler 100.

As shown, computing device 800 may include one or more processors 802, each having one or more processor cores, and system memory 804. The processor 802 may include any type of unicore or multi-core processors. Each processor core may include a central processing unit (CPU), and one or more level of caches. The processor 802 may be implemented as an integrated circuit. The computing device 800 may include mass storage devices 806 (such as diskette, hard drive, volatile memory (e.g., dynamic random access memory (DRAM)), compact disc read only memory (CD-ROM), digital versatile disk (DVD) and so forth). In general, system memory 804 and/or mass storage devices 806 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computing device 800 may further include input/output (I/O) devices 808 such as a display, keyboard, cursor control, remote control, gaming controller, image capture device, one or more three-dimensional cameras used to capture images, and so forth, and communication interfaces 810 (such as network interface cards, modems, infrared receivers, radio receivers (e.g., Bluetooth), and so forth). I/O devices 808 may be suitable for communicative connections with three-dimensional cameras or user devices. In some embodiments, I/O devices 808 when used as user devices may include a device necessary for implementing the functionalities of receiving an image captured by a camera.

The communication interfaces 810 may include communication chips (not shown) that may be configured to operate the device 800 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 810 may operate in accordance with other wireless protocols in other embodiments.

The above-described computing device 800 elements may be coupled to each other via system bus 812, which may represent one or more buses. In the case of multiple buses, they may be bridged by one or more bus bridges (not shown). Each of these elements may perform its conventional functions known in the art. In particular, system memory 804 and mass storage devices 806 may be employed to store a working copy and a permanent copy of the programming instructions implementing the operations, functionalities, techniques, methods, or processes, in whole or in part, associated with FIGS. 1-7, and/or some other process or technique described herein, generally shown as computational logic 822. Computational logic 822 may be implemented by assembler instructions supported by processor(s) 802 or high-level languages that may be compiled into such instructions.

The permanent copy of the programming instructions may be placed into mass storage devices 806 in the factory, or in the field, though, for example, a distribution medium (not shown), such as a compact disc (CD), or through communication interfaces 810 (from a distribution server (not shown)).

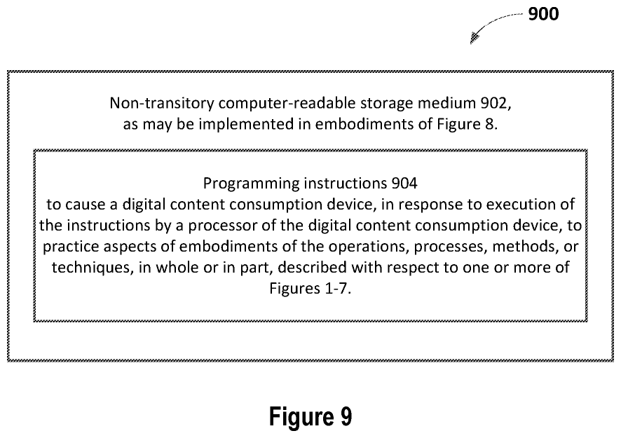

FIG. 9 illustrates an example non-transitory computer-readable storage media 902 having instructions configured to practice all or selected ones of the operations associated with the processes described above. As illustrated, non-transitory computer-readable storage medium 902 may include a number of programming instructions 904. Programming instructions 904 may be configured to enable a device, e.g., computing device 800, in response to execution of the programming instructions, to perform one or more operations, processes, methods, or techniques, in whole or in part, described in reference to FIGS. 1-7, and/or some other process or technique described herein. In alternate embodiments, programming instructions 904 may be disposed on multiple non-transitory computer-readable storage media 902 instead. In still other embodiments, programming instructions 904 may be encoded in transitory computer-readable signals.

In the preceding description, various aspects of the illustrative implementations were described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations were set forth in order to provide a thorough understanding of the illustrative implementations. It will be apparent to one skilled in the art that embodiments of the present disclosure may be practiced without the specific details. In other instances, well-known features have been omitted or simplified in order not to obscure the illustrative implementations.

In the preceding detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the detailed description is not to be taken in a limiting sense.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). More generally, various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The description may have used perspective-based descriptions such as top/bottom, in/out, over/under, and the like. Such descriptions were used to facilitate the discussion and were not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

Example 1 includes an optical coupler comprising: a silicon layer with a surface; a silicon nitride (SiN) waveguide on the surface of the silicon layer; and a cavity at least partially formed by a face of the SiN waveguide, wherein the face and the surface of the silicon layer form an angle of greater than 50 degrees at the cavity.

Example 2 includes the optical coupler of example 1, and/or some other example herein, wherein the SiN waveguide has a thickness of approximately 4 micrometers as measured perpendicularly to the surface of the silicon layer.

Example 3 includes the optical coupler of any of examples 1-2, and/or some other example herein, wherein the face of the SiN waveguide has a smoothness coefficient of less than 1 nanometer (nm).

Example 4 includes the optical coupler of any of examples 1-3, and/or some other example herein, further comprising an oxide at a side of the cavity opposite the SiN waveguide.

Example 5 includes the optical coupler of any of examples 1-4, and/or some other example herein, wherein the SiN waveguide and the cavity are configured to reflect an optical signal based on a difference between a refractive index of the SiN waveguide and a refractive index of the cavity.

Example 6 includes the optical coupler of any of examples 1-5, and/or some other example herein, wherein the face has a linear profile from a portion of the face adjacent to the surface of the silicon layer to a portion of the face that is furthest from the surface of the silicon layer.

Example 7 includes the optical coupler of any of examples 1-6, and/or some other example herein, further comprising a buried oxide layer positioned between the face of the silicon layer and the cavity.

Example 8 includes the optical coupler of example 7, and/or some other example herein, wherein the buried oxide layer is further positioned between the face of the silicon layer and the SiN waveguide.

Example 9 includes an electronic device comprising: an optical source to generate an optical signal; an optical receiver to receive the optical signal, wherein the optical receiver is not co-planar with the optical source; and an optical coupler to reflect the optical signal from the optical source to the optical receiver, wherein the optical coupler includes: a silicon layer with a surface; a silicon nitride (SiN) waveguide on the surface of the silicon layer; and a cavity at least partially formed by a face of the SiN waveguide, wherein the face has a linear profile from a portion of the face adjacent to the surface of the silicon layer and a portion of the face that is furthest from the surface of the silicon layer.

Example 10 includes the electronic device of example 9, and/or some other example herein, wherein the SiN waveguide has a thickness of approximately 4 micrometers as measured perpendicularly to the surface of the silicon layer.

Example 11 includes the electronic device of any of examples 9-10, and/or some other example herein, wherein the face and the surface of the silicon layer form an angle of between 50 degrees and 54.7 degrees at the cavity.

Example 12 includes the electronic device of any of examples 9-11, and/or some other example herein, further comprising an oxide at a side of the cavity opposite the SiN waveguide.

Example 13 includes the electronic device of any of examples 9-12, and/or some other example herein, wherein the SiN waveguide and the cavity are configured to reflect the optical signal based on a difference between a refractive index of the SiN waveguide and a refractive index of the cavity.

Example 14 includes the electronic device of any of examples 9-13, and/or some other example herein, further comprising a buried oxide layer positioned between the face of the silicon layer and the cavity.

Example 15 includes the electronic device of any of examples 9-14, and/or some other example herein, wherein the face of the SiN waveguide has a smoothness coefficient of less than or equal to approximately 10 nanometers (nm).

Example 16 includes a method of forming an optical coupler, wherein the method comprises: forming a cavity in an oxide layer that is on a surface of a silicon layer; epitaxially growing a silicon structure in the cavity; removing at least a part of the oxide layer to expose a face of the silicon structure; shaping a face of the silicon structure such that the face has a linear profile from a portion of the face adjacent to the silicon layer to a portion of the face furthest from the silicon layer, and wherein the face is angled away from the silicon layer by an angle that is between 52 degrees and 54.7 degrees; depositing a silicon nitride (SiN) waveguide on the surface of the silicon layer and adjacent to the face of the silicon structure; and removing the silicon structure to form a cavity adjacent to the SiN waveguide and the silicon layer.

Example 17 includes the method of example 16, and/or some other example herein, wherein the optical coupler is configured to reflect an optical signal that travels through the SiN waveguide at a face of the SiN waveguide adjacent to the cavity.

Example 18 includes the method of any of examples 16-17, and/or some other example herein, wherein removing the silicon structure includes etching.

Example 19 includes the method of any of examples 16-18, and/or some other example herein, wherein shaping the face of the silicon structure includes etching the silicon structure with a crystallographic etchant.

Example 20 includes the method of any of examples 16-19, and/or some other example herein, further comprising placing, prior to the shaping of the face of the silicon structure, an etch-stop layer on at least a portion of the silicon structure.

Example Z01 may include an apparatus comprising means to perform one or more elements of a method described in or related to any of the examples herein, and/or any other method, process, or technique process described herein, or portions or parts thereof.

Example Z02 may include an apparatus comprising logic, modules, or circuitry to perform one or more elements of a method described in or related to any of the examples herein, and/or any other method, process, or technique described herein, or portions or parts thereof.

Example Z03 may include a method, technique, or process as described in or related to any of the examples herein, and/or any other method, process, or technique described herein, or portions or parts thereof.

Example Z04 may include a signal as described in or related to any of the examples herein, and/or any other method, process, or technique described herein, or portions or parts thereof.

Example Z05 may include an apparatus comprising one or more processors and non-transitory computer-readable media that include instructions which, when executed by the one or more processors, are to cause the apparatus to perform one or more elements of a method described in or related to any of the examples herein, and/or any other method, process, or technique described herein, or portions or parts thereof.

Example Z06 may include one or more non-transitory computer readable media comprising instructions that, upon execution of the instructions by one or more processors of an electronic device, are to cause the electronic device to perform one or more elements of a method described in or related to any of the examples herein, and/or any other method, process, or technique described herein, or portions or parts thereof.

Example Z07 may include a computer program related to one or more elements of a method described in or related to any of the examples herein, and/or any other method, process, or technique described herein, or portions or parts thereof.

1. An optical coupler comprising:
a silicon layer with a surface;
a silicon nitride (SiN) waveguide on the surface of the silicon layer; and
a cavity at least partially formed by a face of the SiN waveguide, wherein the face and the surface of the silicon layer form an angle of greater than 50 degrees at the cavity.

2. The optical coupler of claim 1, wherein the SiN waveguide has a thickness of approximately 4 micrometers as measured perpendicularly to the surface of the silicon layer.

3. The optical coupler of claim 1, wherein the face of the SiN waveguide has a smoothness coefficient of less than 1 nanometer (nm).

4. The optical coupler of claim 1, further comprising an oxide at a side of the cavity opposite the SiN waveguide.

5. The optical coupler of claim 1, wherein the SiN waveguide and the cavity are configured to reflect an optical signal based on a difference between a refractive index of the SiN waveguide and a refractive index of the cavity.

6. The optical coupler of claim 1, wherein the face has a linear profile from a portion of the face adjacent to the surface of the silicon layer to a portion of the face that is furthest from the surface of the silicon layer.

7. The optical coupler of claim 1, further comprising a buried oxide layer positioned between the face of the silicon layer and the cavity.

8. The optical coupler of claim 7, wherein the buried oxide layer is further positioned between the face of the silicon layer and the SiN waveguide.

9. An electronic device comprising:
an optical source to generate an optical signal;
an optical receiver to receive the optical signal, wherein the optical receiver is not co-planar with the optical source; and
an optical coupler to reflect the optical signal from the optical source to the optical receiver, wherein the optical coupler includes:
a silicon layer with a surface;
a silicon nitride (SiN) waveguide on the surface of the silicon layer; and
a cavity at least partially formed by a face of the SiN waveguide, wherein the face has a linear profile from a portion of the face adjacent to the surface of the silicon layer and a portion of the face that is furthest from the surface of the silicon layer.

10. The electronic device of claim 9, wherein the SiN waveguide has a thickness of approximately 4 micrometers as measured perpendicularly to the surface of the silicon layer.

11. The electronic device of claim 9, wherein the face and the surface of the silicon layer form an angle of between 50 degrees and 54.7 degrees at the cavity.

12. The electronic device of claim 9, further comprising an oxide at a side of the cavity opposite the SiN waveguide.

13. The electronic device of claim 9, wherein the SiN waveguide and the cavity are configured to reflect the optical signal based on a difference between a refractive index of the SiN waveguide and a refractive index of the cavity.

14. The electronic device of claim 9, further comprising a buried oxide layer positioned between the face of the silicon layer and the cavity.

15. The electronic device of claim 9, wherein the face of the SiN waveguide has a smoothness coefficient of less than or equal to approximately 10 nanometers (nm).

16. A method of forming an optical coupler, wherein the method comprises:
forming a cavity in an oxide layer that is on a surface of a silicon layer;
epitaxially growing a silicon structure in the cavity;
removing at least a part of the oxide layer to expose a face of the silicon structure;
shaping a face of the silicon structure such that the face has a linear profile from a portion of the face adjacent to the silicon layer to a portion of the face furthest from the silicon layer, and wherein the face is angled away from the silicon layer by an angle that is between 52 degrees and 54.7 degrees;
depositing a silicon nitride (SiN) waveguide on the surface of the silicon layer and adjacent to the face of the silicon structure; and
removing the silicon structure to form a cavity adjacent to the SiN waveguide and the silicon layer.

17. The method of claim 16, wherein the optical coupler is configured to reflect an optical signal that travels through the SiN waveguide at a face of the SiN waveguide adjacent to the cavity.

18. The method of claim 16, wherein removing the silicon structure includes etching.

19. The method of claim 16, wherein shaping the face of the silicon structure includes etching the silicon structure with a crystallographic etchant.

20. The method of claim 16, further comprising placing, prior to the shaping of the face of the silicon structure, an etch-stop layer on at least a portion of the silicon structure.
